(19) United States
(12) Patent Application Publication
(10) Pub. No.: US 2017/0284157 A1
(43) Pub. Date: Oct. 5, 2017

(54) OVERHEAD DOOR TILT DETECTION PACKAGE AND METHOD

(71) Applicant: BILMAR DOCK AND DOOR SERVICE INC., Guelph (CA)

(72) Inventors: William John BLAIR, Guelph (CA); William Frew Blair, Cambridge (CA)

(21) Appl. No.: 15/473,306

(22) Filed: Mar. 29, 2017

(30) Foreign Application Priority Data
Mar. 29, 2016 (GB) 1605258.1

(51) Int. Cl. E06B 9/82; G01C 9/06; E06B 9/17

(52) U.S. Cl. CPC E06B 9/82; E06B 9/17; G01C 9/06

(57) ABSTRACT

The invention provides an overhead door tilt protection package comprising an enclosure secured to an overhead door, an electrical connection within the enclosure, electrical components within the enclosure including an electronic tilt detector continuously measuring the angle of door deviation between either a horizontal or a zero-set condition and a determined tilt angle of the bottom bar, producing a deviation signal, determining a stable deviation value from the deviation signal, and setting an electrical deviation condition upon the stable deviation signal reaching a predetermined level. The electrical components produce a visible door power on and door power off condition based upon tilt deviation.

The invention further provides a procedure for improving the operation and safety of overhead doors including measuring deviation of the bottom bar of a door from either horizontal or a pre-set zero condition in real time with an electronic inclinometer, restricting the deviation measurement to a single axis of deviation, averaging the real time signal, determining the average signal as below or above a preset limit and then setting a start/stop condition.

### PRIORITY CLAIM

This application claims priority from GB application #GB-1605258.1, filed Mar. 29, 2016.

### FIELD OF THE INVENTION

The invention relates to the field of overhead roll-up and garage-type doors and security barriers.

### BACKGROUND

Vertical opening garage, factory or tool room doors are commonplace. Most are constructed of an interlinked series of parallel horizontal slats or panels which individually run in in a pair of horizontally offset vertical tracks each attached to the structure. These are most commonly known as roll up or garage-type doors wherein the open condition is an up condition with the door suspended, typically, directly above the opening and/or the interior space. As the slats or panels are interlinked for relative rotation about a horizontal axis between pairs which is perpendicular to the vertical tracks, the individual slats or panels run together in a group either up or down. The panels or slats are often held or pulled as by gravity downwards within their respective tracks from a driven overhead roll in the case of a roll-up door or a horizontal or nearly horizontal storage position as in the case of a garage-type door.

An extreme example is a roll-down security panel or door as commonly found in shopping plazas, malls and in some exterior retail locations. In such cases the slats or panels are replaced by a series of spaced apart security rods interlinked at various positions along their respective lengths to form an open curtain, sometimes referred to as a security grill.

In all such cases, a lot of usage issues, along with wear and tear, relate to interference between the door as a whole or the other moving parts on opening, or more commonly, on closing, as by entranceway obstructions or to other interference with or among the various moving parts, individually or in groups. These are exaggerated by routine wear and tear over the lifetime of use of such a door.

Since the doors are often large they may be quite heavy in an absolute sense, or relatively, as it is commonly the weight of the slat or panel assembly which draws and keeps the door in the down condition, when open and when opening or closing. Due to their wide width and height such doors or security screens are often flexible and somewhat relatively fragile. In most cases the width and height requirements combine with operating requirements and costing to require that the interconnection components such as wheels and axles of rotation include a somewhat variable relationship between the axis of rotation and the rotating parts and/or between the rotating parts such as wheels and their respective tracks. These most vulnerable parts are necessarily the inter-slat connections and the rolling or sliding hardware components as they must accommodate bending in non-vertical situations due to weight considerations and bending in vertical situations arising from use while being self-aligning under the action of downward forces. This is particularly so with security grills. Over time, with or without adverse or unusual usage events such as collisions, entry/exit errors, vandalism or the like the individual slats and components become misaligned, non-planar or completely bent. Such bending may amount to overall bending, with or without a permanent set, or localized bending. While often still usable such doors are out of manufacturer's original specifications. These conditions can and do continue in long periods of use without maintenance and often end in a complete failure event where the door or screen catastrophically ceases to operate at all as it is completely jammed.

The in-use environment can be hard on the doors or screens and related hardware as the doors are often the subject of direct, and often unintentional, physical abuse beyond the simple opening and closing operations. Even such opening and closing operations are conducted by well meaning but unskilled operators often in a hurry or weary from long and active work days whose most important tasks are not related to the detailed operational characteristics of the door beyond the facts of open or closed or in transit. In such cases it is even more likely that the doors or grills could be subjected to abuse or misuse, especially if not operating fully and smoothly in accordance with design specifications.

As a result, doors or security screens can be operated outside of their smooth and quiet initial specifications for long periods.

In the end, it is commonplace for such doors and grills to become jammed between and among their parts alone or in combination with their respective track hardware all the while being subject to strong opening and closing forces, plus the ever present gravitational forces, and use events.

As a result, such doors and grills are typically and increasingly significantly more prone to malfunction by jamming than would be expected by the user. These conditions are progressive in nature and the forces are often allowed to get out of hand by continued operation by inattention, delayed response, or willful attempts to unjam the door by brute force. Many users are extremely casual about operating such a door. Maintenance and/or repair is neglected, avoided or deferred, placing door operations at progressively even higher risk of ultimate failure. This is commonly so as drivers are known to fail to notice damaging interactions between door components and between those components and heavy delivery vehicles.

Efforts to make the doors more robust can only go so far and, then, such efforts are counter to efforts to make the doors faster, lighter and less costly.

The result is a condition where such doors and screens deviate further and further from the initial specifications and quiet smooth operations towards the end-of-use failure condition of a jam and then even further into progressively increasingly permanent damage resulting attempts to avoid the obstruction and/or unjam the door or screen so as to continue short term use ahead of cessation of use for repair or replacement.

### PRIOR ART

There have been many attempts to provide fail safe operational solutions and protections to the door systems to protect the door structures from abusive conditions and jamming.

One of these is shown in U.S. Pat. No. 5,894,267, issued Apr. 13, 1999 to the present inventor. U.S. Pat. No. '267 provides a 2-part mercury switch applied to the base of the door which detects tilting of the door bottom in its nominal in-use surface plane above or below horizontal as an error condition and electrically stops further movement. Such switches have long been effective but are not environmentally friendly. They are however subject to a significant drawback, namely that the deviation angles must be high and the users must be tolerant of false stops due to the random motion of the mercury element itself and whether or not it remains as a single element or becomes separated into random small bits. All of these conditions are inconsistent with a modern high speed and fragile door over long periods of use where the motion of the door components becomes increasingly complex and unpredictable

Another of these is shown in U.S. Pat. No. 7,045,725 issued May 16, 2006 to Gallagher. As far as presently understood in Gallagher, as late as 2006 serious efforts were still being made prevent damage to roll up doors. In the case of Gallagher a complex and costly bi-tapered glass sleeve with end catchment recesses was adapted to accommodate a pair of contacts at each end recess. One of the contacts being annular, the other a point contact. This costly tool is not known by the present inventor to operate reliably well, particularly as the ball bearing is thrown about by reason of the mounting location and thereby acquires significant momentum which is not absorbed. This instability causes a—tilt event—and random unwanted door movement stoppage. Catchment by the end recesses is random and in error due to door operations and inherent door vibrations and movements which trigger unintended door stoppages for which there is no relief. Thus, this device is additionally difficult to install correctly and subject itself to abuse while not being well adapted to modern conditions over a wide variety of door types, sizes, grades and installations.

A still further solution is shown in U.S. Pat. No. 4,396,814 which provides a complex air bladder along the lower periphery of the door but is very complex, costly and difficult to maintain for long in-use periods.

A failed door, particularly partially open or partially closed, results in serious down time in commercial operations as expert repair or replacement is often required after on-site personnel exhaust the locally available and sometimes brutal alternatives. Even urgent expert repair can take days. It is known for door operators to simply use cutting tools and cut away a damaged door, whether it is salvageable or not, due to the high cost of commercial interruptions, especially in just-in-time situations.

In prior devices the wear and tear over a lifetime plus the in-use conditions provide for increasingly sensitive triggering which triggering increasingly interferes with workday requirements which are not often seen by operators as critical until a fatal failure occurs. Such a fatal failure may go beyond simple damage to a garage door to a substantial industrial accident where door parts broken away from control guideways and locks and may fall or slide into work areas. This is especially the case in relation to large industrial doors such as train doors or aircraft hangers where heavy panel components may be bent or even broken more than 20 feet in the air over the work area. Breakage of end-locks or guides may release such panels for catastrophic consequences and injury.

### OBJECTIVES OF THE INVENTION

It is an objective of the present invention to provide a solution to the above-noted problems which is economical to manufacture, simple and quick to install and which is highly reliable in and tolerant to long term and increasingly abusive situations across a wide variety of doors, door types, installations and uses.

It is a further objective of the present invention to provide a detector with improved operator functionality to detect and present relevant abnormal conditions (that is conditional beyond the expected wear-in-use type) in advance of actual fatal damage, with a ready reset, where a decision is deliberately made by the operator to further operate the door to relieve the error condition or cease use for repairs and maintenance.

It is an objective of the invention to provide a single and highly adaptable solution in which development cost, time and effort can be well spread over thousands of installations, each with a low manual labor content with limited skills.

It is yet a further object of the invention to provide a simple device which can detect and record non-standard roll up door conditions over the lifetime of such a door so as to assist in maintenance and prevention of door damage, including damage from worn or misaligned parts.

### STATEMENT OF THE INVENTION

The invention provides an overhead powered door tilt protection package comprising a water resistant enclosure adapted to be secured to an overhead door adjacent its bottom bar, an electrical connection within the enclosure extending to the operating electrical power of an overhead door, electrical components within the enclosure including an electronic tilt detector continuously measuring the angle of door deviation between either a horizontal or a zero-set condition and a determined tilt angle of the bottom bar, producing a deviation signal, determining a stable deviation value from the deviation signal, and setting an electrical deviation condition upon the stable deviation signal reaching a predetermined level. The electrical components are adapted to produce a visible door power on and door power off condition upon deviation condition reaching the predetermined level and to interact with electrical power of the door and start or stop door operation respectively in association with the start or stop condition.

The invention further provides a tilt protection package wherein the deviation value is averaged and restricted for measurement about a single axis in real time, the axis being perpendicular to the door and horizontal.

The invention further provides a tilt package which presents a go and no-go, on and off or proceed and stop condition visible to the door operator and a reset condition for manual and or powered use.

The invention additionally provides a procedure for improving the operation and safety of overhead powered doors including measuring deviation of the bottom bar of a door from either horizontal or a pre-set zero condition in real time with an electronic inclinometer, restricting the deviation measurement to a single axis of deviation, averaging the real time signal, determining whether the average signal is below or above a preset limit and then setting a start/stop condition within the power operations of the overhead door in accordance with the above/below determination.

The invention also provides a procedure where the start/stop condition may optionally be reset by an operator for manual or powered operations despite the start/stop condition.

### DRAWINGS

FIG. 1 is an overall vertical elevation view of the tilt detector of the invention in an installed condition.

FIG. 2 is a pictorial view of a typical roll up door indicating the areas of concern, particularly where small deviations may occur over long periods of use.

FIGS. 3 and 4 are pictorial views of partially damaged doors.

FIG. 5 is a pictorial view of the green/red tilt event display.

FIG. 6 is a preferred circuit diagram identified as to function.

FIG. 7A is an elevation view showing a typical installation in a before condition.

FIG. 7B is an elevation view showing a typical installation in an after condition.

### THE PREFERRED EMBODIMENT

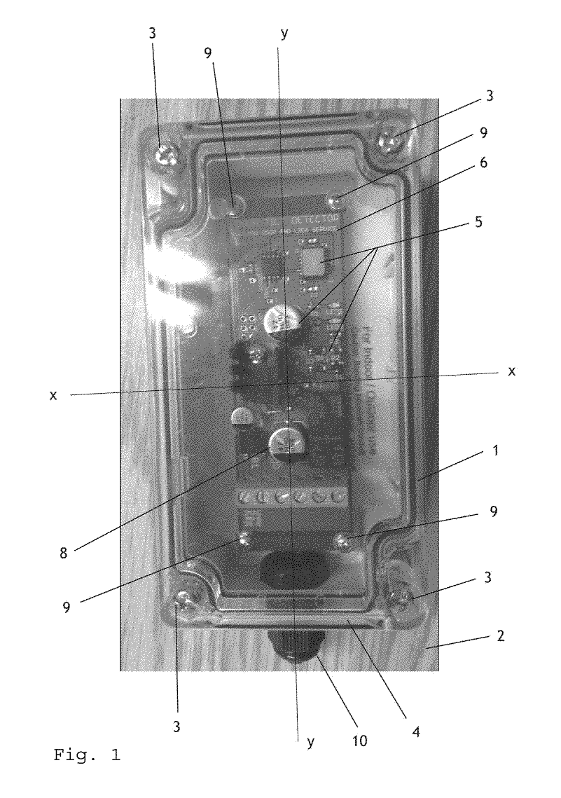

The preferred embodiment of the invention as shown in FIG. 01 comprises a tilt detection package 1 arranged to be secured to the face 2 of a roll up door, preferably adjacent the lower extremity of the door as by fasteners 3. The tilt package 1 preferably includes a weather and site specific protective cover 4 for individual tilt detection components 5 which are preferably secured to a separate circuit board 6. The components 5 includes a programmable electronic inclinometer 8 capable of measuring degrees of tilt from a reference angle, such as the horizontal, in small time and value increments. Preferably the increments are 2 degrees from horizontal or less, preferably much less, and the inclinometer has no operative inertial mass. Electronic inclinometers 8 suitable for the preferred embodiment have almost no mechanical weight or inertia and are almost immune to vibrations and many abrupt changes in motion of the base and provide a real time value for the inclination reading.

The inclinometer 8 preferably includes a 0-set or level-set switching capacity which is operable at a range of small angles from the reference angle (horizontal).

Most preferably inclinometer 8, alone or in conjunction with components 5, includes a programmable tilt angle limit switch, and averaging function and a learning function. The tilt angle limit switch provides for the on/off operational condition of the door mechanism. The learning function is programmed using common programming techniques to adapt to initial (upon installation) motions of the package 1 and, over time, preferably, to adapt to increasingly random and violent motions of the package as the door ages in use to provide a steady-state-type inclination signal representative of the operational average tilt of the door panel 2.

Circuit board 7 is fixed to package 1 and cover 4 as by fasteners 9 for a permanent and stable relationship providing x-y axes of rotation in the plane of the door panel face 2. Electrical lines are connected between the tilt package 1 and the electrical circuit powering the door as by expansible coiled or other wire or wiring fixed to the door where either the switch condition will operate a high power switch in the door power circuit or the on/off power will be switched directly within the tilt package 1.

The programming will preferably restrict the inclinometer results to a stable representation of the tilt angle 10 of the package 1 and, thus, door panel 2 about the z-axis perpendicular to the door panel face 2 and eliminate inclination or motion results about the x or y axes.

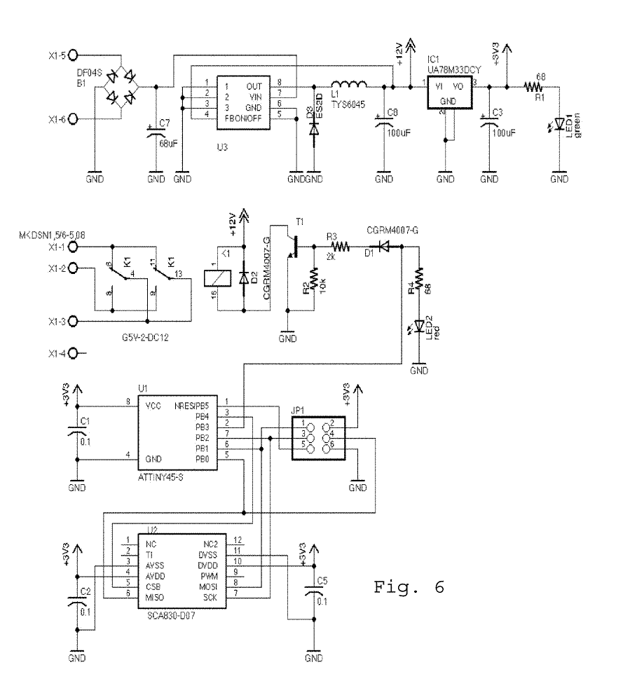

Once 0-set, the inclinometer 8 and the components 5 are powered as by electrical circuit connection provided as at 10 as to present a visible green/red operational condition from the board 6 through the cover 4 into the relevant workplace as shown in FIG. 5.

The green condition indicated on the display is readily visible to an operator or passer by as being measured average door tilt less than a small defined angle, preferably, 2, 5 or 10 degrees from horizontal. The red condition indicated on as measured average door tilt of more than the small defined angle, namely a relevant a door tilt event.

The red/green display, by the tilt event, is electrically connected to door power systems so as to present an operational (green) condition where power to the door up/down switch circuitry is provided and an inoperative condition (red)where said power is prevented from reaching the up-down circuitry.

A door-up/door-down operator switch is provided within operational eyesight of said display and is only operable to electrically control the up/down powered condition of the powering motor when said display is in the green condition. In a tilt event condition, the door and its driving motor are permanently disconnected from electrical power and up/down switching is inoperative.

The tilt assembly includes structure to provide for a non-zero tolerance to the horizontal level of the installation and a reset operative to reset the 0-tilt condition in accordance with the actual operational conditions at the time of reset. Thus, upon installation with the door or grill assembly factory-fresh the reset will set the 0 deflection condition and provide a green display condition. Upon a tilt event, damaging or not, being cleared the reset will set a new baseline condition as green which accommodates the then-present condition of the door which may be a 0 angle or horizontal condition or some other baseline angle condition present at the time and required for door operations whether such operations are temporary or permanent

A manual up/down system of the well-known type is preferably included. The manual up/down, often a chain hoist, is not interconnected with the tilt package so that the door may be moved manually under low loading conditions to relieve against minor jamming/tilt events or unusual tilt conditions. Once a tilt event has been alleviated and door returned to horizontal or other operable condition the tilt package will automatically return to the green-go condition and up/down switching may provide for powered door movement.

A tilt by-pass switch is also included in some installations for careful usage of powered door movement by skilled operators where necessary, such as with heavy industrial doors or emergency situations.

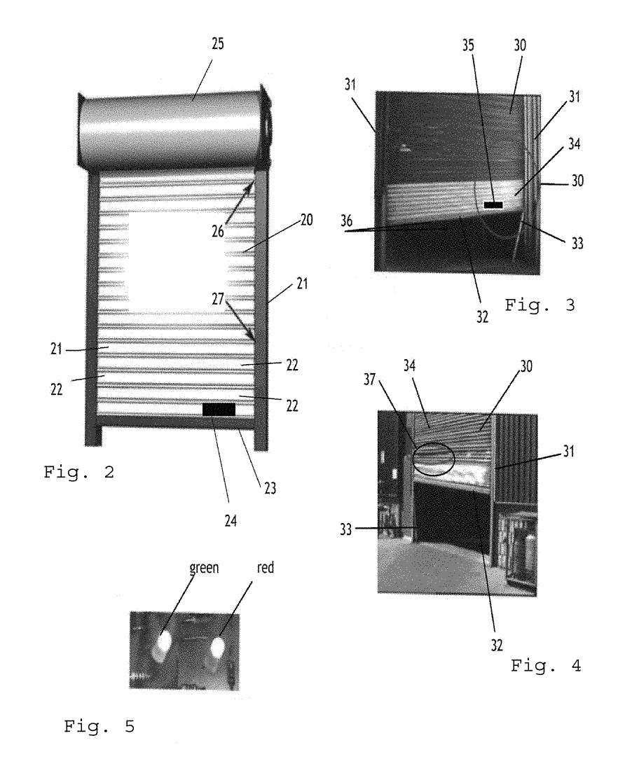

FIG. 02 is a pictorial view of the tilt detector 24 as installed to an industrial roll up door 20. Door 20 includes panels 22 intersecured to each other and retained by door side rails 21 for up down door movement by door bottom 23 in relation to door roll 25 secured to the building. In many cases particular problem areas occur as at 26 and 27 in relation to twisted end locks and bent guides which, if uncorrected, will fatally damage door 20.

FIG. 03 is a pictorial view of the tilt detector installation shown in FIG. 02 with the door up/down action impeded for illustration purposes by a bar 33. Door 30 is retained in position with side rails 31 and operated for up/down movement of bottom edge 32. Upon an average departure of the tilt detector 35 from the 0-set or horizontal condition, as at 36, of 2, 5 or 10 degrees, as set, preferably 2 degrees, the red/green condition will be set to red from green and power will be disconnected from drive motors, thus stopping the door on a just-in-time basis.

FIG. 04 is a further pictorial view of the tilt detector installation of FIG. 02 wherein door 30 bottom edge 32 has encountered bar obstacle 33 and driven door bottom 32 off angle for a tilt condition stoppage of powered operation. Permanent and possibly fatal damage to the door 30 is shown in FIG. 04 is imminent as shown by bunching and buckling as at 36 in FIG. 04. Further operation of door 30 could tear door panels completely free of side rails 31 and the door 30 itself.

FIG. 05 is a plan view of the red/green condition indicator as seen by the operator while in use with one light green and the other red. A red condition prevents electrically driven operation of the upper door roll 25.

FIG. 06 is a circuit diagram for the preferred embodiment of the electrical components 5 as driving the red/green indicators of FIG. 05.

In FIG. 06 the labeled components are as follows:

B1—Bridge Rectifier

U1—Programmable Microcontroller

U2—Precision Solid-State Inclinometer

U3—12V Switching Power Regulator

IC1—3.3 VDC Voltage Regulator

LED1—Power Indicator

LED2—Status Indicator K1—Double-Pole Wire Terminal

JP1—Programming Header Connector

C1—C8—Power Supply Filtering Capacitors

D1—Protection Diode

D2—Inductive Kickback Protection Diode

D3—Power Supply Feedback Diode

L1—Power Supply Inductor

R1, R4—Current Limiting Resistors

R2, R3—Voltage Divider Resistors

T1—Relay Coil Switching Transistor

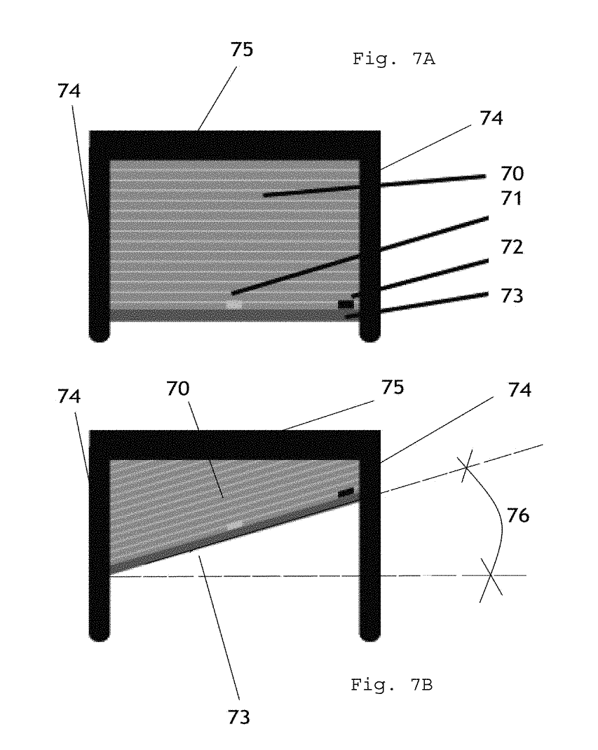

FIG. 07 shows a typical full installation of the tilt detector and door combination of the invention in both normal condition and in a tilt event. Roll-up door 70 is includes centrally mounted detector 71 in a substantially open condition with bottom bar 73 just above the fully closed position. Door 70 is restrained between side rails 74 with end-locks and guides to close the opening below upper element 75. Typically, the electrical connections to main power, as at junction box 72, are provided by the installer to connect detector 71 to operating power for the door. Upon a pathway restriction being encountered bottom bar 73 is slowed down or completely restrained against further downward or upward motion as the case may be and continues such motion until bottom bar 73 acquires a tilt angle 76 in relation to horizontal or the 0-set angle at which point principal power is disconnected from the drive motor, the tilt condition is set to red and the door stops its driven motion.

The scope of the present disclosure is by way of example rather than by way of limitation, and the subject disclosure does not preclude inclusion of such modifications, variations, and/or additions to the present subject matter as would be readily apparent to a person skilled in the art.

What we claim is:

1. An overhead powered door tilt protection package comprising:
(a) a water resistant enclosure adapted to be secured to an overhead door adjacent its bottom bar,
(b) an electrical connection within the enclosure extending to the operating electrical power of an overhead door,
(c) electrical components within the enclosure including an electronic tilt detector continuously:
i. measuring the angle of door deviation between either a horizontal or a zero-set condition and a determined tilt angle of the bottom bar,
ii. producing a deviation signal,
iii. determining a stable deviation value from the deviation signal, and
iv. setting an electrical deviation condition upon the stable deviation signal reaching a predetermined level,
(d) the electrical components adapted to produce a visible door power on and door power off condition upon deviation condition reaching the predetermined level,
(e) the electrical components adapted to interact with electrical power of the door and start or stop door operation respectively in association with the start or stop condition.

2. An overhead powered door tilt protection package as claimed in claim 1 wherein the stable deviation value is an average of the real time deviation signal.

3. An overhead powered door tilt protection package as claimed in claim 2 wherein the angle of door deviation is measured about a single axis.

4. An overhead powered door tilt protection package as claimed in claim 3 wherein the single axis is perpendicular to the door and horizontal.

5. An overhead powered door tilt protection package as claimed in claim 3 wherein the water resistant enclosure is adapted to be secured to the face of an overhead door.

6. An overhead powered door tilt protection package as claimed in claim 5 wherein the inclinometer is restrained to provide only a deviation signal in relation to a single axis of deviation.

7. An overhead powered door tilt protection package as claimed in claim 2 wherein the inclinometer is restrained to provide a deviation signal in respect of only one axis perpendicular to the plane of the door.

8. An overhead powered door tilt protection package as claimed in claim 7 wherein deviation angle of door deviation lies in the plane of the door when open.

9. An overhead powered door tilt protection package as claimed in claim 6 including a reset switch to restore operation to the door despite the start or stop condition.

10. An overhead door package comprising a roll up doorway adapted to be raised and lowered between guide rails from a fully lowered position closing a doorway to an opened position away from the doorway with the door components retained above the doorway when opened, the improvement comprising the tilt detector of claim 1.

11. The invention further provides a tilt package which presents a go and no-go, on and off or proceed and stop condition visible to the door operator and a reset condition for manual and or powered use.

12. A procedure for improving the operation and safety of overhead powered doors including measuring deviation of the bottom bar of an overhead door from either horizontal or a pre-set zero condition in real time with an electronic inclinometer, restricting the deviation measurement to a single axis of deviation, averaging the real time signal, determining whether the average signal is below or above a preset limit, and, then setting a start/stop condition within the power operations of the overhead door in accordance with the above/below determination.

13. A procedure for improving the operation and safety of overhead powered doors as claimed in claims 12 including a procedure where the start/stop condition may be reset by an operator for manual or powered operations despite the start/stop condition.
